(19) United States
(12) Patent Application Publication
(10) Pub. No.: US 2026/0031680 A1
(43) Pub. Date: Jan. 29, 2026

(54) APPARATUS AND METHOD FOR HARNESSING ELECTRICAL ENERGY FROM HVAC CONDENSER

(71) Applicants: Bradley N. Duke, LINCOLNTON, NC (US); Donald F. Ballentine, LINCOLNTON, NC (US)

(72) Inventors: Bradley N. Duke, LINCOLNTON, NC (US); Donald F. Ballentine, LINCOLNTON, NC (US)

(21) Appl. No.: 19/281,338

(22) Filed: Jul. 25, 2025

Related U.S. Application Data
(60) Provisional application No. 63/676,326, filed on Jul. 26, 2024.

(51) Int. Cl. H02K 7/14; F24F 1/20

(52) U.S. Cl. CPC H02K 7/14; F24F 1/20

(57) ABSTRACT

Apparatus and method for harnessing electrical energy from an HVAC condenser includes a fan motor and fan connected to an output shaft of the fan motor. A primary generator also operatively and mechanically coupled to the output shaft generates electrical energy when the fan motor operates the fan. The primary generator is electrically connected through a voltage booster/regulator to supply electrical energy to one or more chargeable batteries configured to provide auxiliary power to an external load. A control module in electrical connection with the primary generator and the fan motor operates the fan motor to power the fan and thereby spin the primary generator. A secondary generator and secondary fan operatively and mechanically coupled with the fan motor, or in flow communication with the fan, supplies electrical energy to one or more chargeable batteries configured to provide auxiliary power to an external load.

### FIELD OF THE INVENTION

The present invention relates generally to an apparatus and method for harnessing electrical energy from a heating, ventilation and air conditioning (HVAC) condenser. The harnessed electrical energy is then stored in a battery storage system. More particularly, the invention is an apparatus and method for generating electrical energy from the condenser unit of an HVAC system and storing the electrical energy in at least one battery of a battery storage system.

### BACKGROUND OF THE INVENTION

The cost of electrical energy to consumers has increased dramatically over the years, partly due to additional government regulations for producing electrical energy and recently introduced “green energy” initiatives. As a result, apparatus and methods have been introduced to harness and store electrical energy for supplemental, auxiliary or emergency use. One example is the installation of solar panels on the exterior of a structure, such as a commercial building or residential dwelling. However, solar panels remain expensive to install and are highly dependent on the availability of sunlight in the ambient environment. Furthermore, the amount of electrical energy that can be produced by a solar panel system is often insufficient to satisfy the needs of a typical commercial building or residence. Another example is an electrical energy generator. However, electrical energy generators require a separate energy source, such as liquid fuel (gasoline, propane, kerosene, etc.), to produce electrical energy. Consequently, a generator is typically employed only as a back-up source of electrical energy in an emergency situation, such as a power outage. Still another example is a battery electrical energy storage system. However, a battery electrical energy storage system likewise requires a separate energy source to charge the batteries, and further, the batteries tend to dissipate the stored electrical energy over time.

Most commercial buildings and residential dwellings are equipped with a heating, ventilation, and air conditioning (HVAC) system. The typical HVAC system has an indoor unit for circulating air and an outdoor unit that contains a compressor and a condenser unit. The compressor and condenser work together to transform a refrigerant that runs through the system. The compressor reduces the volume of the liquid refrigerant while in a gaseous state and the condenser returns the refrigerant from the gaseous state into the liquid state. The condenser includes a series of condenser coils that receive the refrigerant as a high pressure, superhot liquid vapor. A fan operated by a fan motor draws ambient air over the condenser coils to cool the refrigerant and expel heat from the refrigerant to the outdoor environment. As a result, the condenser fan motor and fan operate regularly and frequently to disperse heated air to the ambient atmosphere.

It is apparent a need exists for harnessing and storing electrical energy that is both efficient and cost-effective. A particular need exists for an apparatus and method for harnessing and storing electrical energy that does not require expensive components or a separate energy source. A specific need exists for an apparatus and method for harnessing and storing electrical energy that takes advantage of the kinetic energy already being produced by the condenser of a conventional HVAC system. A more specific need exists for generating electrical energy from the condenser of an HVAC system and storing the electrical energy in a battery for supplemental, auxiliary or emergency use.

Certain aspects, objects, features and advantages of the present invention will be made apparent by, or will be readily understood and appreciated by, those skilled in the relevant art as exemplary embodiments of the invention shown in the accompanying drawing figures are described in greater detail. It is intended that all such aspects, objects, features and advantages of the invention envisioned by this disclosure of exemplary embodiments be encompassed by the scope of the appended claims, given their broadest reasonable interpretation and construction as would be understood by those skilled in the relevant art. These aspects, objects, features and advantages of the invention, as well as others not expressly disclosed, may be accomplished by any of the exemplary embodiments described herein and illustrated in the accompanying drawings. However, it should be appreciated that the drawing figures are for illustrative purposes only, and that many modifications, changes, revisions and substitutions may be made to any of the exemplary embodiments without departing from the general concepts of the invention and the broadest reasonable interpretation and construction of the claim terms.

### BRIEF DESCRIPTION OF THE DRAWINGS

The aforementioned aspects, objects, features and advantages of the present invention will be more fully understood and appreciated when considered in conjunction with the accompanying drawing figures, in which like reference characters designate the same or similar parts throughout the several views.

FIG. 1 is a schematic illustration of an apparatus and method for harnessing electrical energy from an HVAC condenser and storing the electrical energy in a battery storage system according to an exemplary embodiment of the present invention.

FIG. 2 is a schematic illustration of an apparatus and method for harnessing electrical energy from an HVAC condenser and storing the electrical energy in a battery storage system according to another exemplary embodiment of the present invention.

FIG. 3 is a schematic illustration of an apparatus and method for harnessing electrical energy from an HVAC condenser and storing the electrical energy in at least one battery for use in an electrical energy distribution system.

### DETAILED DESCRIPTION OF EXEMPLARY EMBODIMENTS OF THE INVENTION

The drawing figures illustrate exemplary embodiments of an apparatus and method for harnessing electrical energy and storing the electrical energy in a battery storage system according to the present invention. In general, kinetic energy produced by the fan motor and fan of the condenser of an HVAC system is captured and converted to electrical energy by a direct current (DC) generator or alternating current (AC) generator. The electrical energy produced by the generator is stored in a battery storage system for supplemental, auxiliary or emergency use. For example, the electrical energy stored in the battery system may be used immediately to reduce energy costs by supplying power to other electrical components, or by supplying power back to the HVAC system. Alternatively, the electrical energy stored in the battery storage system may be used subsequently during peak electrical energy requirement times to power electrical components, such as night lights, cameras and alarm systems. In addition, the electrical energy stored in the battery storage system may be reserved for emergency back-up use, for example in the event of a power outage. Regardless, the electrical energy harnessed and stored in the battery storage system may be used as an additional source of electrical energy to supplement or substitute for an existing electrical component or system.

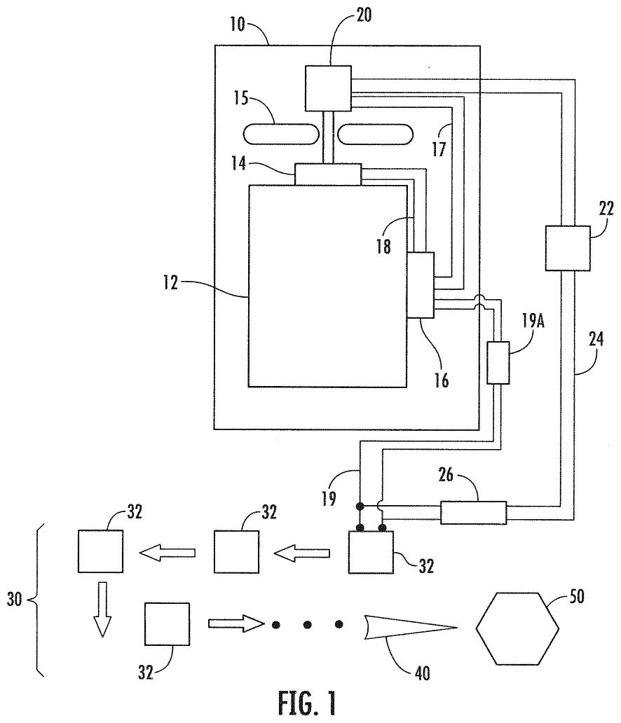

In the exemplary embodiment illustrated by FIG. 1, the apparatus and method comprise an outdoor unit 10 of an HVAC system having a condenser unit 12 for heating or cooling a commercial building or residential dwelling. The condenser 12 operates as needed in a conventional manner to heat or cool a commercial building or residential dwelling. Condenser 12 includes a fan motor 14 and a fan 15 that is powered by the fan motor 14. By way of example and not limitation the fan motor 14 may be an alternating current (AC) induction motor. However, it should be appreciated that the components of the HVAC system are shown schematically for purposes of illustration only, and therefore, may be configured, packaged, altered, modified or combined in any other suitable manner. For purposes of this disclosure of the present invention it is only relevant that a fan motor 14 and fan 15 are present to produce kinetic energy as a result of operation of the HVAC system.

As illustrated by FIG. 1, a direct current (DC) generator 20 is operatively and mechanically coupled (i.e., attached) to an output shaft of the fan motor 14 of the condenser 12 that operates the fan 15. As such, when the fan motor 14 is activated to turn/rotate the fan 15, the DC generator 20 spins to generate electrical energy. As depicted herein by FIG. 1, the DC generator 20 is located external to the condenser 12. However, DC generator 20 may alternatively be located at any convenient location, including within the condenser 12 of the outdoor unit 10. Regardless, the electrical energy produced by the DC generator 20 is output from the generator to a battery storage system, indicated generally by reference character 30, having at least one chargeable battery, indicated by reference character 32, as will be described in greater detail hereafter.

As illustrated by FIG. 1, the DC generator 20 is electrically coupled to an optional programmable control module 16 via an electrical wire harness 17. The control module 16 may be used to operate the fan motor 14 to power the fan 15 periodically and thereby cause the DC generator 20 to produce electrical energy when the battery storage system 30 needs charging. Accordingly, control module 16 is electrically coupled at 18 to the starter motor of the fan motor 14 through a normally open set of contacts within the control module 16 and is electrically coupled at 19 to the at least one chargeable battery 32. An optional electrical shunt 19A may be provided to monitor the voltage level of the battery storage system 30 and activate the control module 16 to turn on the fan motor 14 and thereby spin the DC generator 20 to charge the at least one battery 32 when the voltage level of the battery storage system 30 is low. In addition, or alternatively, the control module 16 may be programmed to operate the DC generator 20 and thereby produce electrical energy according to a predetermined schedule or upon demand from an external command. If desired, control module 16 may include a wireless transceiver (not shown) for remote programming and operation. In a further embodiment, the control module 16 is configured to operate the DC generator 20 in response to an operating condition of the HVAC system, for example when supplemental electrical energy is needed to power the outdoor unit 10 during peak electrical power requirements or in the event of an electrical power outage.

As further illustrated by FIG. 1, the DC generator 20 is electrically coupled to the battery storage system 30 via a voltage booster and/or voltage regulator 22 via electrical wire harness 24. The voltage booster and/or voltage regulator 22 creates and maintains a fixed output voltage irrespective of changes to the input voltage or load conditions. An optional electrical shunt 26 may be provided between the voltage booster and/or voltage regulator 22 and the battery storage system 30. The electrical shunt 26 generates a low-resistance electrical path that enables the electrical current to flow to an alternative point in the circuit. As such, the electrical shunt 26 is preferably a current shunt resistor. As previously mentioned, the battery storage system 30 comprises at least one chargeable battery 32, but preferably comprises a plurality of chargeable batteries 32 that are electrically connected together in series. By way of example and not limitation, the chargeable battery 32 or series of chargeable batteries 32 may each be a conventional dry-cell lithium ion battery or a conventional 12 volt battery.

As further illustrated by FIG. 1, the at least one battery 32 or the series of batteries 32 of the battery storage system 30 are electrically coupled to a direct current to alternating current (DC/AC) inverter 40. In one embodiment, the inverter 40 may be configured to rapidly switch the direction of the DC power source (i.e., the battery 32 or series of batteries 32) to an external electrical energy load, indicated generally by reference character 50, to create the illusion of an AC electrical energy source. Regardless, the AC electrical energy created by the DC/AC inverter 40 is available to be supplied to the load 50. By way of example and not limitation, the load 50 may be a residential electrical panel, a commercial electric grid, a further electrical energy storage apparatus, device, system or the like. Furthermore, the load 50 may be utilized to supply electrical power back to the outdoor unit 10 of the HVAC system, to any other electrical apparatus, device or system, or to the further electrical energy storage system.

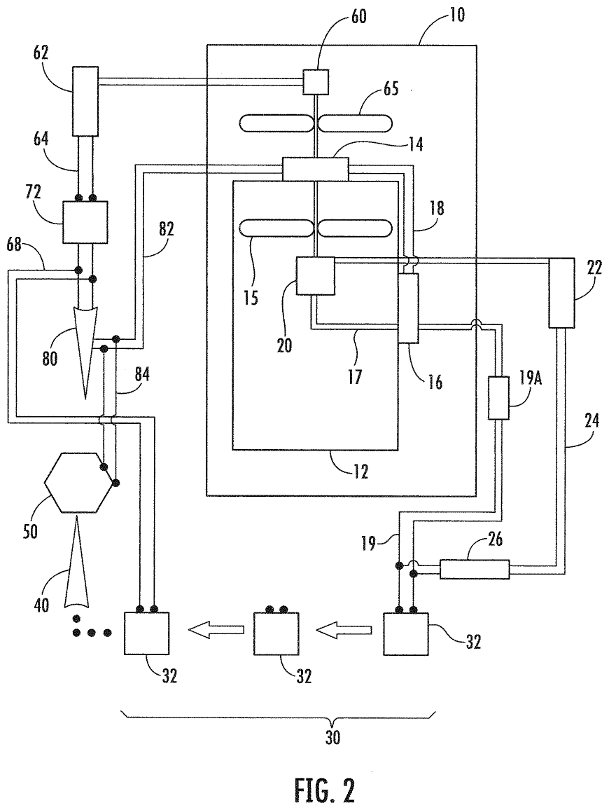

FIG. 2 illustrates an apparatus and method for harnessing electrical energy from an HVAC condenser according to another exemplary embodiment of the present invention. In general, the kinetic energy produced by the fan motor 14 and fan 15 of the condenser 12 of the outdoor unit 10 of the HVAC system is also captured and converted to electrical energy to provide auxiliary power for the fan motor 14. In the exemplary embodiment of FIG. 2, like reference characters are used to designate the same or similar parts, elements or components previously described with reference to the exemplary embodiment of FIG. 1. As illustrated by FIG. 2, the outdoor unit 10 of an HVAC system comprises condenser 12 having fan motor 14 for powering fan 15 via an output shaft from the fan motor 14. As shown in FIG. 2, the fan motor 14 is located exterior to the condenser 12. However, the fan motor 14 may be, and generally will be, located within the interior of the condenser 12 below a wire mesh grate disposed over the top of the condenser 12 that prevents access to the fan motor 14 and the fan 15 from outside the condenser 12.

Regardless, a primary DC generator 20 is operatively and mechanically coupled to the fan motor 14 via an output shaft of the fan motor 14 to generate electrical energy that is supplied to an external electrical energy storage system, such as battery storage system 30 comprising at least one chargeable battery 32, through a voltage booster and/or voltage regulator 22 via an electrical wire harness 24, as previously described. Optional electrical shunt 26, for example in the form of a current shunt resistor, may be provided between the voltage booster and/or voltage regulator 22 and the battery storage system 30 to generate a low-resistance electrical path that enables the electrical current to flow to an alternative point in the circuit.

A programmable control module 16 may be electrically coupled with the primary DC generator 20 via electrical harness 17 in the manner and for the purposes previously described. The control module 16 is also electrically coupled at 18 with the fan motor 14 to power the fan 15 periodically and thereby cause the primary DC generator 20 to produce electrical energy when the battery storage system 30 needs charging. Accordingly, control module 16 is electrically coupled at 19 to the at least one chargeable battery 32 and to the starter motor of the fan motor 14 and through a normally open set of contacts within the control module 16. Optional electrical shunt 19A may be provided to monitor the voltage level of the battery storage system 30 and activate the control module 16 to operate the fan motor 14 and thereby spin the primary DC generator 20 to charge the at least one battery 32 when the voltage level of the battery storage system 30 is low.

In addition to the components of the like components of the embodiment of FIG. 1, the embodiment of FIG. 2 further comprises a secondary DC generator 60. In the embodiment illustrated by FIG. 2, the secondary generator 60 is likewise operatively and mechanically coupled to the fan motor 14 via an output shaft and a secondary fan 65 is disposed between the fan motor 14 and the secondary DC generator 60. The secondary DC generator 60 is likewise turned/spun by the output shaft of the fan motor 14 to generate auxiliary electrical energy to power the fan motor 14, for example during peak electrical energy requirements and in the event of a power outage. In yet another embodiment, the secondary fan 65 is mounted to the top of the condenser 12 independent from the output shaft of the fan motor 14. When the fan motor 14 powers the fan 15 the secondary fan 65 rotates from the upward airflow generated by the fan 15 and turns/spins the secondary DC generator 60 instead of, or in addition to, the output shaft of the fan motor 14.

In either instance, the secondary fan 65 and secondary DC generator 60 (and the fan motor 14 if it is located exterior to the condenser 12) are enclosed within a housing of the outdoor unit 10, or alternatively, within a shroud mounted on the condenser 12 and topped with a wire mesh grate. Regardless, secondary DC generator 60 is similarly electrically coupled to a secondary electrical energy storage system, such as a chargeable battery 72, through a voltage booster and/or voltage regulator 62 via a wire harness 64. The electrical energy stored in the chargeable battery 72 is available to a direct current to alternating current (DC/AC) inverter 80 to provide auxiliary AC power to the fan motor 14 as needed, for example via electrical harness 82. Alternatively, or in addition, the electrical energy stored in the chargeable battery 72 may be supplied via electrical harness 68 to charge the battery storage system 30. Still further, the electrical energy from battery 72 may be provided to an external electrical energy load 50 from the DC/AC inverter 80 via an electrical harness 84 in the manner previously described with reference to FIG. 1.

As will be readily understood and appreciated by those skilled in the relevant art, the primary DC generator 20 and the secondary DC generator 60 harness kinetic energy from the fan motor 14 that causes the fan 15 and the secondary fan 65 to turn and thereby spin the primary DC generator 20 and the secondary DC generator 60, respectively. The primary DC generator 20 supplies electrical energy to charge the battery storage system 30. The secondary DC generator 60 supplies electrical energy to a chargeable battery 72 to provide auxiliary power to the fan motor 14. The chargeable battery 72 may also supply electrical energy to the battery storage system 30 and/or to the external electrical energy load 50 in addition to, or instead of, the electrical energy supplied by the primary DC generator 20. The apparatus and method of the exemplary embodiment illustrated in FIG. 2 may further comprise a low-resistance electrical shunt, such as a current shunt resistor, in the same manner and for the same purpose as shunt 19A or shunt 26 described with reference to the embodiment of FIG. 1

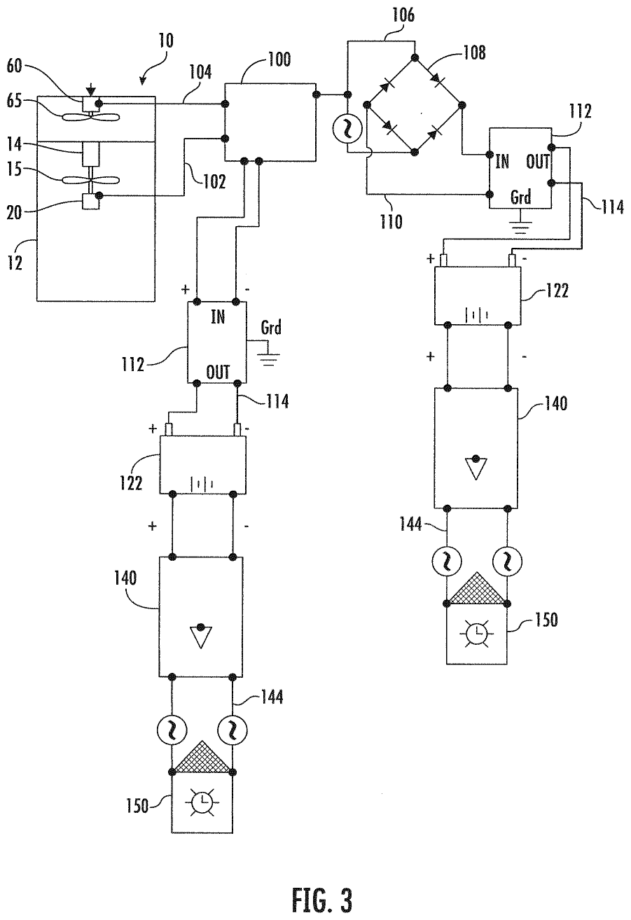

FIG. 3 illustrates an apparatus and method for harnessing electrical energy from an HVAC condenser according to another exemplary embodiment of the present invention. In general, the kinetic energy produced by the fan motor 14 and fan 15 of the condenser 12 of the outdoor unit 10 of the HVAC system is captured and converted to electrical energy by both a primary generator 20 and a secondary generator 60 to provide power to an external load 150, such as a commercial building or residential home electrical system. In the exemplary embodiment of FIG. 3, like reference characters are used to designate the same or similar parts, elements or components previously described with reference to the exemplary embodiment of FIG. 1 and/or FIG. 2. As illustrated by FIG. 3, the outdoor unit 10 of an HVAC system comprises condenser 12 having fan motor 14 for powering fan 15 via an output shaft of the fan motor 14.

As shown in FIG. 3, the fan motor 14 is located within an interior defined by the condenser 12. For example, the fan motor 14 may be, and generally will be, located within the interior of the condenser 12 below a wire mesh grate or the like that prevents access to the fan motor 14 and the fan 15 from outside the condenser 12. A DC generator 20 is operatively and mechanically coupled to the fan motor 14 via the output shaft of the fan motor 14 to generate direct current (DC) electrical energy to be supplied to an external electrical energy storage system, such as at least one chargeable battery 122. Alternatively, or in addition, an AC generator 60 is operatively and mechanically coupled to a secondary fan 65 to generate alternating current (AC) electrical energy to likewise be supplied to an external electrical energy storage system, such as at least one chargeable battery 122. For purposes of this disclosure, the DC generator 20 may also be referred to as the “primary DC generator” on the “primary side” of the apparatus, and the AC generator may similarly be referred to as the “secondary AC generator” on the “secondary side” of the apparatus.

As illustrated by FIG. 3, the primary DC generator 20 is electrically coupled to an electrical junction box 100 at 102 and the secondary AC generator 60 is likewise electrically coupled to the electrical junction box 100 at 104. By way of example, the electrical junction box 100 may be made waterproof and located exterior to the condenser 12 and the outdoor unit 10. Furthermore, the secondary AC generator 60 and the secondary fan 65 may be located exterior to the condenser 12, for example as an aftermarket component that is configured in airflow communication with the fan 15 of the condenser 12. In a beneficial embodiment, the primary DC generator 20 is located within the condenser 12 above or below the fan motor 14 and/or the fan 15, while the secondary AC generator 60 and the secondary fan 65 are located above the fan motor 14 and the fan 15.

Regardless, as illustrated by FIG. 3, the primary DC generator 20 is electrically connected to at least one battery 122 from the electrical junction box 100 through a voltage booster and/or voltage regulator 112 via an electrical wire harness 114 in the manner previously described with reference to FIGS. 1 and 2. Conversely, the secondary AC generator 60 is first electrically connected from the electrical junction box 100 through an electrical harness 106 to a bridge rectifier circuit 108. The bridge rectifier circuit 108 operates to convert the alternating current (AC) from the secondary AC generator 60 to direct current (DC). In a beneficial embodiment, the bridge rectifier circuit 108 is a “full-wave” bridge rectifier employing four (4) diodes in a bridge configuration to ensure that both halves of the alternating current (AC) waveform are used to produce a pulsating direct current (DC) output, which is typically more efficient than a “half-wave” rectifier. The direct current (DC) output from the bridge rectifier circuit 108 is then provided to at least one battery 122 through a voltage booster and/or voltage regulator 112 via an electrical harness 114, similarly to the direct current (DC) electrical energy delivered to at least one battery 122 from the primary DC generator 20.

As previously described, the voltage booster and/or voltage regulator 112 creates and maintains a fixed output voltage irrespective of changes to the input voltage or load conditions. An optional electrical shunt (not shown in FIG. 3, but similar to 19A in FIGS. 1 and 2) may be provided to monitor the voltage level of the at least one battery 122 and activate a programmable control module (not shown in FIG. 3, but similar to 16 in FIGS. 1 and 2) to operate the fan motor 14 and thereby spin the primary DC generator 20 and/or the secondary AC generator 60 to charge the at least one battery 122 when the voltage level of the battery is low. An optional electrical shunt (not shown in FIG. 3, but similar to 26 in FIGS. 1 and 2), such as a current shunt resistor, may be provided between the voltage booster and/or voltage regulator 112 and the at least one battery 122 to generate a low-resistance electrical path that enables the electrical current to flow to an alternative point in the circuit. As in the previous embodiments, the at least one battery 122 may be any type of chargeable battery. By way of example and not limitation, the at least one battery 122 may be a conventional dry-cell lithium ion battery or a conventional 12 volt battery.

As further illustrated by FIG. 3, the at least one battery 122 is electrically coupled to a direct current to alternating current (DC/AC) power inverter 140. By way of example and not limitation, the inverter 140 converts twelve volts direct current (12V DC) to one hundred twenty volts alternating current (120V AC). The alternating current (AC) electrical energy created by the DC/AC power inverter 140 is available to be supplied to an external load 150. By way of example and not limitation, the external load 150 may be a residential electrical panel, a commercial electric grid, a further electrical energy storage apparatus, device, system or the like. Furthermore, as previously described, the electrical energy from the load 150 may be utilized to supply electrical power back to the outdoor unit 10 of the HVAC system, to any other electrical apparatus, device or system, or to the further electrical energy storage system.

FIG. 3 illustrates an apparatus for separately harnessing electrical energy from the condenser 12 of an outdoor unit 10 of an HVAC system. Specifically, FIG. 3 shows a primary side of the apparatus comprising primary DC generator 20 operable for harnessing electrical energy from the kinetic energy produced by the fan motor 14 and the fan 15 of the condenser 12 and supplying the electrical energy to at least one battery 122. FIG. 3 further shows a secondary side comprising secondary AC generator 60 operable for harnessing electrical from the kinetic energy produced by the secondary fan 65 and supplying the electrical energy to at least one battery 122.

However, those of ordinary skill in the art will readily understand and appreciate that the primary side of the apparatus comprising primary DC generator 20 and the secondary side of the apparatus comprising secondary AC generator 60 may be combined within the electrical junction box 100. Furthermore, the separate voltage booster and/or voltage regulators 112, batteries 122, DC/AC power inverters 140 and loads 150 may be combined to eliminate redundancy and reduce complexity. The separate primary side and secondary side comprising the primary DC generator 20 and the secondary AC generator 60, respectively, are illustrated and described merely for purposes of explanation.

Regardless of the foregoing detailed description of exemplary embodiments of the present invention, the optimum structure of the invented apparatus, and the manner of use, operation and steps of the invented method, as well as reasonable equivalents thereof, are deemed to be readily understood and apparent by those skilled in the relevant art. Accordingly, equivalent relationships to those shown in the accompanying drawing figures and described in the written description are intended to be encompassed by the disclosure of the present invention and the ordinary and customary meaning of the appended claims, the foregoing being considered as illustrative only of the general concepts and principles of the invention.

Furthermore, since numerous modifications and changes will readily occur to those skilled in the relevant art, the exemplary embodiments illustrated and described herein are not intended to limit the invention to the specific configuration, construction, materials, manner of use and operation disclosed. Instead, all obvious modifications and reasonably foreseeable equivalents thereof should be construed as falling within the scope of the present invention as defined by the broadest reasonable construction and interpretation of the appended claims in view of the accompanying written description and drawing figures as would be understood by those skilled in the relevant art.

That which is claimed is:

1. An apparatus for harnessing electrical energy from a heating, ventilation and air conditioning (HVAC) system comprising:
a condenser having a fan motor and a fan powered by the fan motor;
at least one generator operatively and mechanically coupled with the fan motor for generating electrical energy; and
an electrical energy storage system in electrical connection with the at least one generator and operable for storing the electrical energy generated by the at least one generator.

2. The apparatus according to claim 1, further comprising a control module in electrical connection with the fan motor and operable for controlling operation of the fan motor.

3. The apparatus according to claim 2, wherein the control module controls the operation of the fan motor to spin the at least one generator operatively an mechanically coupled with the fan motor and in electrical connection with the electrical energy storage system.

4. The apparatus according to claim 1, further comprising a voltage booster and/or voltage regulator in electrical connection with the at least one generator and with the electrical energy storage system.

5. The apparatus according to claim 1, wherein the electrical energy storage system comprises at least one chargeable battery.

6. The apparatus according to claim 5, wherein the at least one chargeable battery is a dry-cell lithium ion battery or a twelve volt direct current (12V DC) battery.

7. The apparatus according to claim 5, wherein the at least one chargeable battery comprises a plurality of chargeable batteries electrically connected together in series.

8. The apparatus according to claim 1, further comprising at least one direct current to alternating current (DC/AC) inverter electrically connected to the electrical energy storage system and configured to provide electrical power to an external load.

9. The apparatus according to claim 1, wherein the electrical energy storage system is configured to supply electrical power to at least one of an external electrical energy source, an external electrical device and/or an external electrical system.

10. The apparatus according to claim 1, wherein the at least one generator comprises a primary generator and a secondary generator.

11. The apparatus according to claim 10, wherein at least one of the primary generator and the secondary generator are operatively and mechanically coupled with an output shaft of the fan motor.

12. The apparatus according to claim 11, wherein at least one of the primary generator and the secondary generator are operable for supplying electrical energy to at least one of the fan motor and the electrical energy storage system.

13. The apparatus according to claim 10, wherein the primary generator is operatively and mechanically coupled with an output shaft of the fan motor, and wherein the secondary generator is operatively and mechanically coupled with a secondary fan that is in flow communication with the fan powered by the fan motor.

14. The apparatus according to claim 10, wherein the primary generator is a direct current (DC) generator and the secondary generator is an alternating current (AC) generator.

15. The apparatus according to claim 14, wherein the secondary generator is electrically connected to a bridge rectifier circuit for converting an alternating current (AC) to a direct current (DC).

16. The apparatus according to claim 10, further comprising at least one voltage booster and/or voltage regulator in electrical connection with the primary generator and the electrical energy storage system and/or in electrical connection with the secondary generator and the electrical energy storage system.

17. A method for harnessing electrical energy from a heating, ventilation and air conditioning (HVAC) system comprising:
providing a condenser having a fan motor and a fan powered by the fan motor;
operating the fan motor to turn an output shaft of the fan motor;
operatively and mechanically coupling at least one generator with the output shaft of the fan motor;
spinning the at least one generator to generate an electrical energy;
supplying the electrical energy generated by the at least one generator to an electrical energy storage system.

18. The method according to claim 17, wherein the at least one generator comprises at least one of a primary generator and a secondary generator, and further comprising providing at least one voltage booster and/or voltage regulator in electrical connection with the at least one of the primary generator and/or the secondary generator.

19. The method according to claim 17, wherein the at least one generator comprises a primary generator and a secondary generator, the method further comprising operatively and mechanically coupling the primary generator with the output shaft of the fan motor, operatively and mechanically coupling the secondary generator with a secondary fan, and positioning the secondary fan in flow communication with the fan powered by the fan motor.

20. The method according to claim 17, wherein the at least one generator comprises a primary DC generator and a secondary AC generator, the method further comprising operatively and mechanically coupling the primary DC generator with the output shaft of the fan motor, and electrically connecting the secondary AC generator with a bridge rectifier circuit for converting an alternating current (AC) to a direct current (DC) to be supplied to the electrical energy storage system.
